(19) United States
(12) Patent Application Publication
(10) Pub. No.: US 2004/0226669 A1
(43) Pub. Date: Nov. 18, 2004

(54) Latchless window shade apparatus

(76) Inventor: Tony F. Webb, San Diego, CA (US)

Correspondence Address: KENNETH S WATKINS JR, 372 RIVER DR, DAHLONEGA, GA, 30533, US

(21) Appl. No.: 10/439,433

(22) Filed: May 16, 2003

(51) Int. Cl. E06B 9/56

(52) U.S. Cl. 160/299

(57) ABSTRACT

A window shade apparatus [101] utilizes a shade [107] spirally wrapped about a roller assembly [103]. A bottom rail [111] attached to the bottom end of the shade incorporates spring-biased brake assemblies engaged in longitudinal slots [115A, 115B] of side rails [117A, 117B]. The roller assembly uses a helical spring with a relatively large outer diameter, long compressed length and small wire diameter to provide relatively constant tension on the shade. The apparatus allows latchless positioning of the shade and is especially effective in windows having long lengths.

### FIELD OF THE INVENTION

The present invention relates to window shades and, more particularly, to stringless, roll-type window shades.

### BACKGROUND OF THE INVENTION

Window shades perform a variety of important functions including providing privacy, control of room light, and thermal and audio insulation of windows. Roll-type window shades have been in use for a period of time. Louvered-type window shades have become popular, but are limited in the use of shade materials, cost and complexity. The strings or cords used in louvered-type window shades limits their use in applications prohibiting use of these materials, for example in certain medical and institutional buildings.

Conventional roll-type window shades utilize a flexible sheet spirally wrapped around a spring-powered roll mechanism. Various roll latch mechanisms latch the roll when the shade is extended in the desired position. While this shade design is adequate for many applications, they are unsuitable when high shade stability is required, since no tension is maintained on the extended shade except for the weight of the shade and bottom rail. U.S. Pat. No. 4,458,739 discloses a insulative roll-up shade utilizing two channels on either side of the window having a pile fabric which seals the sides of the fabric. A latch latches the shade in the fully extended position. While this type of shade is useful for the fully extended position, it is limited in use for adjusting a set position and maintaining it. An improved window shade is needed which has more flexibility for use in many new applications.

### OBJECTS AND SUMMARY OF THE INVENTION

Therefore, an object of the present invention is to provide a window shade that can be positioned in any extended position while maintaining relatively constant tension on the shade for improved stability.

Another object of the present invention is to provide a window shade that does not require a latching mechanism so that the shade can be quickly adjusted and re-adjusted, for example by a single hand.

Another object of the present invention is to provide a window shade that utilizes a friction brake assembly that allows selection of braking force.

Another object of the present invention is to provide a window shade that can be used with extended-length windows.

Another object of the present invention is to provide a window shade that does not utilize strings or cords.

Another object of the present invention is to provide a window shade that utilizes a helical spring in a roller mechanism providing relatively constant torque on the window shade over the full effective length of the shade.

Still another object of the present invention is to provide a window shade that is simple and low in cost.

The window shade apparatus of the present invention utilizes a shade of flexible sheet or film material with one end attached to a roller assembly. A bottom rail is attached to a second end of the shade. A helical spring in the roller assembly provides nearly constant torque to the shell of the roller assembly to provide nearly constant tension on the shade regardless of the position of the bottom rail.

A friction brake assembly in each end of the bottom rail engages a channel in each of two respective side rails of the window shade assembly. The side rails are attached to the side window jambs by fasteners. A finger grip on the front or inside of the bottom rail allows positioning of the rail from inside the window jamb.

For use in long windows, such as those having lengths greater than 4 feet, or length to width ratios of the window greater than 1, a roller assembly spring having characteristics opposite of those normally used for long window openings in conventional roll type shades is employed. A helical spring having a relatively large outside diameter, relatively long compressed length and small wire size provides less than normal lift force, while providing relatively constant torque (and tension on the shade) over the full operating length of the window shade. The lower than normal lift force allows the brake assemblies to maintain the bottom rail in the set position even near the fully extended position. The relatively constant tension on the shade also provides sufficient tension for shade stability even at small extension positions.

The brake assemblies of the bottom rail utilize friction brake pads that engage channels in the side rails. A brake spring biases the friction pad against a surface such as one or more raised ridges or rails in the channels. The brake spring bias is selected to provide a braking force sufficient to maintain bottom rail position at the lower positions, while being low enough to allow easy positioning by the user. The bottom rail has a weight attachment means such as a circular channel for retaining weights utilized in very narrow or short windows with such a spring.

### BRIEF DESCRIPTION OF THE DRAWINGS

These and other features, aspects and advantages of the present invention will become better understood with regard to the following description, appended claims and accompanying drawings where:

FIG. 1 is an exploded perspective drawing of the latchless window shade apparatus of the present invention having a spring roller assembly supported in brackets, a spirally wrapped shade having a bottom rail engaged to side rails attached to the side window jambs, and brake assemblies in the bottom rail frictionally engaging channels in the side rails;

FIG. 2 is a cross section drawing of the roll shell, shade and lower rail of the window shade apparatus taken along lines 2-2 of FIG. 1;

FIG. 3 is an exploded perspective drawing of the roller assembly of the window shade apparatus;

FIG. 4 is a backside elevation drawing of the bottom rail of the window shade apparatus;

FIG. 5 is a cross section of the side rail showing engagement with the friction brake pad of the brake assembly;

FIG. 6 is a perspective drawing of the helical spring of the roller assembly shown in the compressed condition; and

FIG. 6A is a detail drawing of one end of the helical spring of FIG. 6.

### DESCRIPTION OF THE PREFERRED EMBODIMENTS

The following is a description of the preferred embodiments of a window shade apparatus for latchless positioning over an extended length.

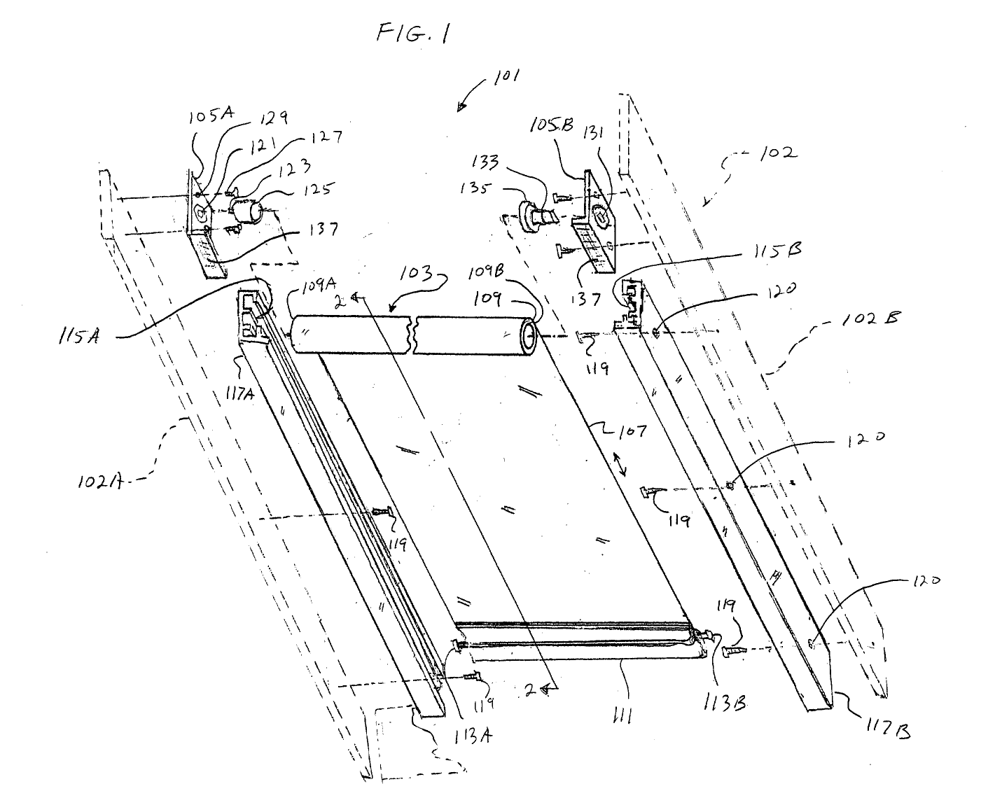

FIG. 1 is an exploded perspective drawing of a preferred embodiment of a window shade apparatus 101 having a roller assembly 103 supported from brackets 105A and 105B attached to respective sides 102A, 102B of a window jamb 102. The top of window jamb 102 is omitted for clarity. Shade 107 is made of a flexible sheet or film material such as fabric or plastic sheet and spirally wrapped around roll shell 109 of roller assembly 103.

Bottom rail 111, attached to the bottom end of shade 107 provides a means to grasp shade 107 for pulling upwards or downwards from roll shell 109. Friction brake assemblies 113A, 113B on either end of bottom rail 111 engage slots 115A, 115B of side rails 117A, 117B and provide a means to secure shade 107 in the desired location without discrete latches. Fasteners 119, inserted in fastener holes 120 secure side rails 117A, 117B to window jamb sides 102A, 102B.

In the preferred embodiments, bracket 105A comprises a bearing surface such as aperture 121 for support of rotating shaft 123 of rotating coupling 125 inserted into end 109A of roll shell 109. Fasteners 127 secure bracket 105A to window jamb side 102A at attachment holes 129.

Slot 131 of bracket 105B provides non-rotatable support to non-rotating shaft 133 of roller assembly 103. Bearing 135, inserted in end 109B of roll shell 109, allows shell 109 to rotate on non-rotating shaft 133. An attachment element such as a hook and loop fastener 137 on brackets 105A, 105B allow easy installation of a cover molding (not shown) extending across the roller assembly between the brackets.

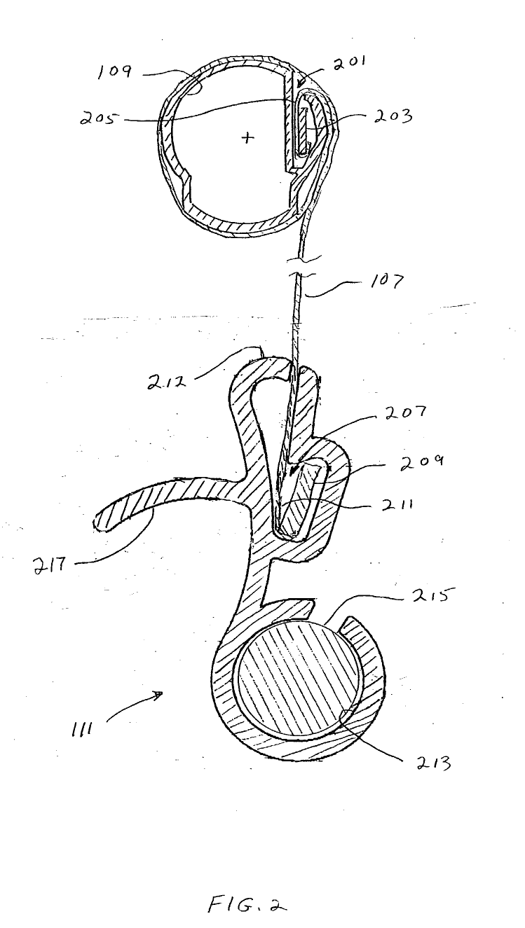

FIG. 2 is a cross section of roller assembly 103, shade 107 and bottom rail 111 taken along lines 2-2 of FIG. 1. Slot 201 of roll shell 109 retains upper shade bar 203 attached to top shade end 205. Slot 207 of bottom rail 111 retains lower shade bar 209 attached to bottom shade end 211. The slot and bar attachment of top and bottom ends of shade 107 provides a secure and convenient method of attachment by insertion of the respective retaining bars from the end of the slots. Spring ledge 212 provides a tight fit against shade 107 to prevent accumulation of dirt and debris in slot 211. Circular slot 213 provides an attachment means or retainer for bottom rail weight 215. Finger grip or ledge 217 provides a convenient grip to raise or lower bottom rail 111 from the inside of the window.

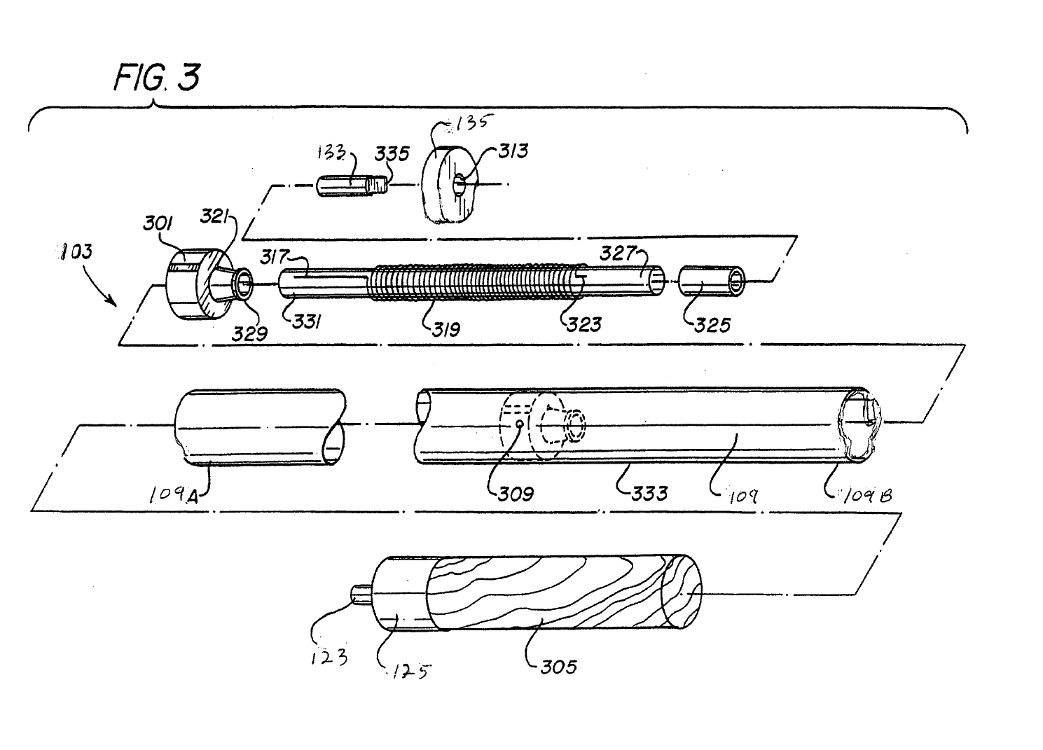

FIG. 3 is an exploded drawing of roll assembly 103 that provides a winding surface and a winding force for shade 107 of FIG. 1. Roll assembly 103 comprises rotating shaft 123 which supports roll shell end 109A and is connected to drive bushing 301 by coupling 125 and shaft extension 305. Drive bushing 301 is fixed inside roll shell 109 by a fastener 309. Non-rotating shaft 133 supports roll shell end 109B on sleeve portion 313 of bearing 135. Bearing 135 is press fitted into end 109B of roll shell 109. End 317 of helical spring 319 is fixed in aperture 321 of drive bushing 301. End 323 of helical spring 319 is fixed to support rod 327 fixed to non-rotating shaft 133 by ferrule 325. Support rod 327 supports helical spring 319 and is, in turn, supported by bearing portion 329 of drive bushing 301. Bearing portion 329 of drive bushing 301 provides a rotational fit between bearing portion 329 and support rod end 331.

Upon downward pull on bottom rail 111, roll shell 109 rotates, rotating end 317 of helical spring 319 with respect to end 323. Helical spring end 323 is rotationally fixed by key portion 335 of non-rotating shaft 133 by slot 131 of bracket 105B (see FIG. 1). Thus, withdrawal of shade 107 from roll shell 109 creates a retracting torque on roll shell 109, resulting in a withdrawal force on the upper end of shade 107.

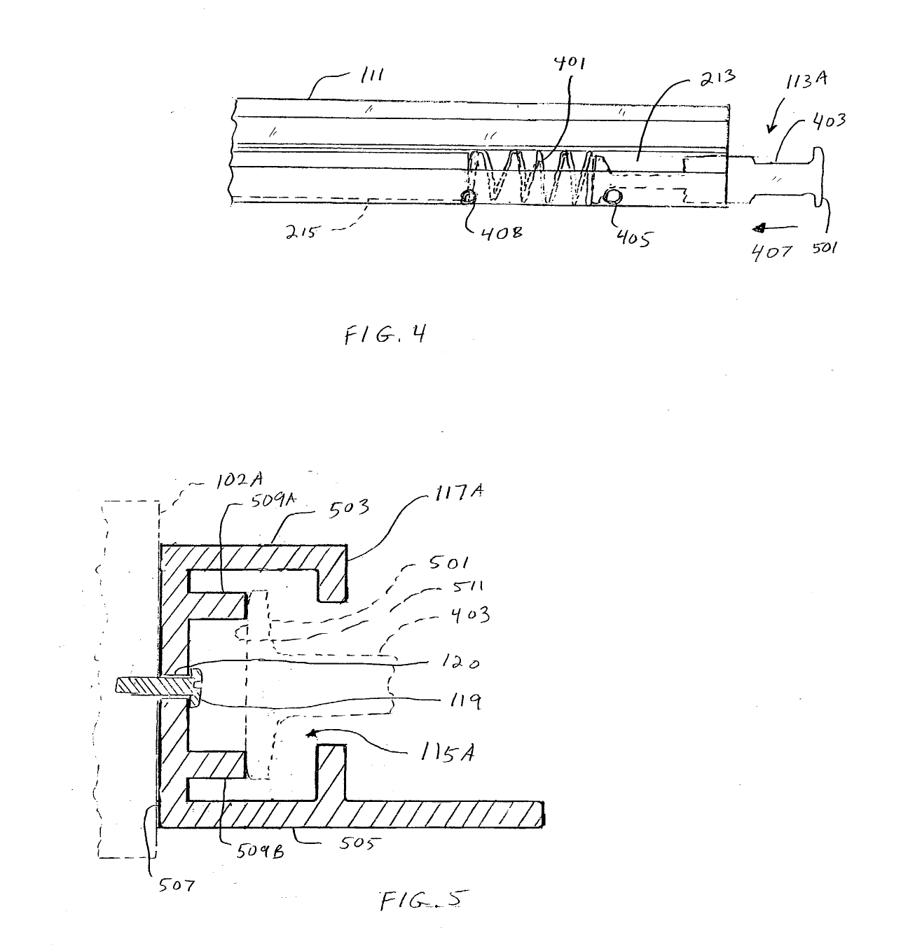

FIG. 4 is a detail back side elevation drawing of bottom rail 111 showing brake assembly 113A and weight 215 retained in circular slot 213. Helical brake spring 401 of brake assembly 113A biases brake rod 403 in an outward direction. A stop such as rivet stop 405 stops rod 403 at the outward position as shown in the figure. Rivet stop 408 retains spring 401 against spring 401 bias in the positions shown in the figure. Helical spring 401 allows inward motion of brake rod 403 in slot 213 in the direction shown by arrow 407 against spring bias.

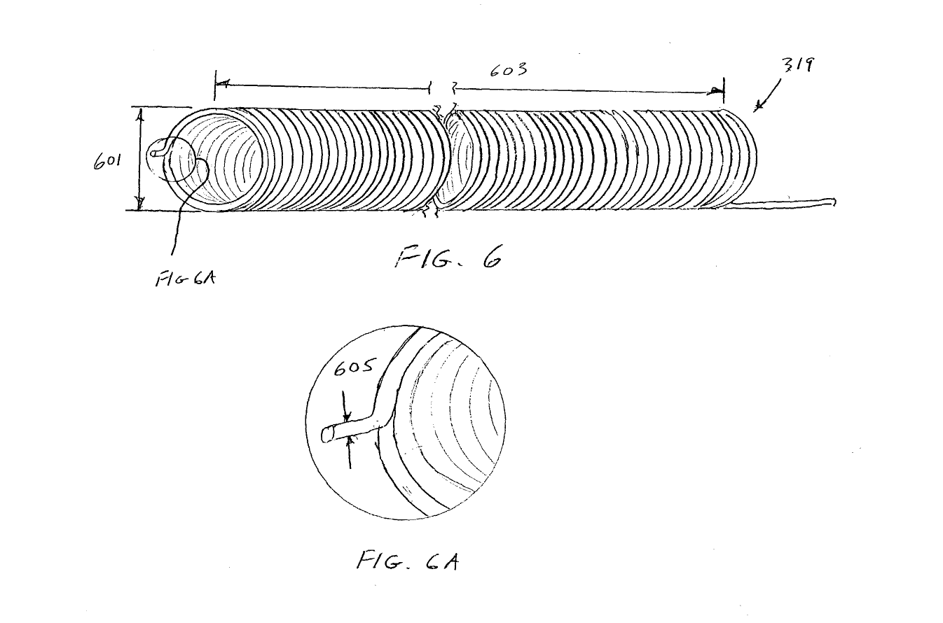

FIG. 5 is a cross section of side channel 117A with friction brake pad 501 of brake rod 403 and side jamb 102A shown in phantom lines. Side portions 503, 505 and base portion 507 form engagement slot 115A. Rails 509A and 509B in engagement slot 115A provide a friction surface for brake surface 511 of brake pad 501 of brake assembly 113A and prevent interference or engagement of brake pad 501 with fastener 119. The materials of brake pad 501 and rails 509A, 509B are selected to provide the desired friction for the brake assemblies. Side portion 505 is extended inward as compared to side portion 503 and acts as a trim strip for side channel 117A.

The brake assemblies of FIG. 1 provide frictional engagement between the bottom rail and the respective side channels to retain bottom rail 111 in the position in which it is placed without additional latching means. This braking action is sufficient for typical installations. For many window applications, the upward force provided by springs typically used in roller shade applications results in excessive upward force when the shade is in a lower position. Increasing brake assembly braking action such as increasing spring 401 strength is not practical in these applications since raising and lowering the shade requires excessive effort.

Surprisingly, spring designs utilizing relatively large spring diameters, long spring lengths, and small wire size, opposite of that normally used in longer windows, provide a lower but relatively constant upward force and allow use of reasonable brake spring pressure for long windows. Such springs result in relatively constant torque throughout the operating range of the window to keep the shade taught and stable, yet a sufficiently low torque so as not to overcome the braking force at the lower positions.

### EXAMPLE 1

A helical spring for roller assembly 103 for use with a window having a shade width of 6 feet and an extended shade length of 8 feet utilizes a helical steel spring with a spring outer diameter (D) 601 of 0.890 inches, a compressed or coil contacting length (L) 603 of 32 inches, and an effective wire diameter (d) 605 of 0.056 inches. The spring factor (SF) of this spring is defined mathematically as:

SF=DL/d=509 in

where all units are in inches.

The effective wire diameter (d) is defined as:

d=√(4A/π)

Where A is the cross sectional area of the wire in square inches. For circular cross section wire, d is the measured diameter of the wire. Spring factors for springs used in the present invention typically range from about 250 in to over 500 in.

FIG. 6 is a perspective drawing of a preferred embodiment of the helical spring 319 of roller assembly 103 shown in a compressed or “coils touching” condition. The spring outer diameter is identified as 601, and the compressed length is shown as 603 in the figure. FIG. 6A is a detail drawing of end 323 of spring 319 showing effective wire diameter 605.

In the preferred embodiments, the SF of roller assembly spring 319 is greater than 250 in.

In the more preferred embodiments, the SF of roller assembly spring is greater than 350 in. In the most preferred embodiments, the SF of the roller assembly spring is greater than 500 in.

Another method of identifying the spring performance of the present invention is to relate the spring characteristics to the roller assembly application. For example, it was found that the spring factor characteristics identified above applied to the torque produced by the spring just before lockup of the spring provides a measure of the constant, low-torque spring power characteristic of the invention. Several design factors of the roller assembly such as the support rod 327 diameter and the amount of extension of the installed spring in the roller assembly, determine the maximum number of turns of the shell before lockup. This combination of spring factor and application characteristics are defined as the application factor or AP where:

AF=SF*N/T=NLD/Td

where N is the number of turns of the roll shell of the roller assembly from the retracted condition to two turns before lockup and T is the measured torque in inch-lbs of the roll shell at the value of N.

### EXAMPLE 2

A helical spring for roller assembly 103 for use with a window having a shade width of 6 feet and an extended shade length of 8 feet utilizes a helical steel spring with a spring outer diameter (D) 601 of 0.890 inches, a compressed or coil contacting length (L) 603 of 32 inches, and an effective wire diameter (d) 605 of 0.056 inches. By experiment, the measured torque of the roll shell two turns before lockup (111) was measured as 9.75 in-lbs. The application factor (AP) of this system is:

AF=SF*N/T=509 inch*111 in/9.75 in-lb=5795/lb

AF for window shade designs of the present invention typically range from 2000/lb or 3000/lb to over 5000/lb.

For some window shades having extended shade lengths, the selected SF of the helical spring and/or selected AF of the window shade apparatus, selected resistance of the brake assemblies, and addition of weight(s) to the bottom rail are combined to provide a shade which stays in the set position for any extended length along the side rails. The selection of a high SF and/or AF allows use of smaller brake assembly resistance for ease of use of the device, and use of less, or no, added weight in the bottom rail.

In the preferred embodiments of the invention, the roll shell and shaft brackets are made of a metal such as aluminum or steel. The roller assembly helical spring is heat-treated alloy steel. The side rails and bottom rail are extruded plastic such as PVC or ABS. The shade may be any flexible sheet material such as fabric, plastic sheet, fiber-reinforced plastic, or screen materials.

Accordingly, the reader will see that the Latchless Window Shade Apparatus provides a window shade that remains in a set position. The shade provides the following additional advantages:

The shade maintains its position without latches;

The shade maintains its holding feature in windows of longer length than conventional shades;

No strings or cords are used in the apparatus; and

The shade is simple and low in cost.

Although the description above contains many specifications, these should not be construed as limiting the scope of the invention but merely providing illustrations of some of the presently preferred embodiments of this invention. For example, the roller assembly brackets may be integral with the side rails. A single spring may be used to bias both brake assemblies. Detents in the side rails can be included. Or, the bias element of the brake assemblies may be located in the side rails. Thus the scope of the invention should be determined by the appended claims and their legal equivalents, rather than by the examples given.

1. A window shade apparatus for latchless positioning, the apparatus installable in a window jamb and comprising:
a roller assembly comprising a rotatable shell operably connected to a window jamb attachment element by a helical spring;
a shade made of a flexible sheet material comprising a first end connected to said rotatable shell and a second end connected to a bottom rail;
a pair of side rails, each of said pair of side rails comprising a longitudinal engagement element comprising a first friction brake surface and a first fastener element for fastening said each of said pair of side rails to opposite sides of said window jamb;
said bottom rail comprising a pair of brake assemblies, each of said pair of said brake assemblies comprising a brake element comprising a second friction brake surface engageable to said first friction brake surface of said longitudinal engagement element of said each of said pair of side rails;
a bias element disposed in said bottom rail operably engaged with said brake element of at least one of said pair of brake assemblies whereby said bottom rail is positioned and maintained in a set position selectable from a first end portion to a second end portion of said each of said pair of side rails;
said window shade apparatus comprising an application factor wherein a product of a compressed length of said helical spring, outer diameter of said helical spring, and a number of revolutions of said rotatable shell from a retracted position to two turns before a lockup condition of said roller assembly divided by a product of an effective wire diameter of said helical spring and a torque of said rotatable shell at said two turns before a lockup condition is at least 2000/pound, said compressed length of said helical spring said outer diameter of said helical spring, and said effective wire diameter of said helical spring are measured in inches and said torque of said rotatable shell is measured in inch-pounds.

2. The window shade apparatus of claim 1 wherein said helical spring is selected to comprise a spring factor greater than 250 inch wherein said spring factor is a product of an outside diameter of said helical spring and a compressed length of said helical spring divided by an effective wire diameter of said helical spring wherein said outside diameter of said helical spring, said compressed length of said helical spring and said effective wire diameter of said helical spring are measured in inches.

3. The window shade apparatus of claim 2 wherein said spring factor is greater than 350 inch.

4. The window shade apparatus of claim 2 wherein said spring factor is greater than 500 inch.

5. The window shade apparatus of claim 1 wherein said roller assembly comprises a rotating shaft on a first end of said rotatable shell and a non-rotating shaft rotatably supported from a second end of said rotatable shell by a bearing, and a first end of said helical spring is fixed to said rotatable shell and a second end of said helical spring is fixed to said non-rotating shaft.

6. The window shade apparatus of claim 5 comprising a rotating shaft bracket engageable with said rotating shaft and a second fastener element for attaching said rotating shaft bracket to said window jamb.

7. The window shade apparatus of claim 6 comprising a non-rotating shaft bracket engageable with said non-rotating shaft and a third fastener element for attaching said rotating shaft bracket to said window jamb.

8. The window shade apparatus of claim 1 wherein said longitudinal engagement element is a longitudinal slot in each of said pair of side rails, said bias element disposed in said bottom rail is a brake spring and said brake element is a brake shoe engageable in said longitudinal slot.

9. The window shade apparatus of claim 1 wherein said bottom rail comprises a means for attaching a weight.

10. A window shade apparatus for latchless positioning, the apparatus installable in a window jamb and comprising:
a roller assembly comprising a rotatable shell operably connected to a window jamb attachment element by a helical spring, said helical spring selected to comprise a spring factor greater than 250 inch wherein said spring factor is a product of an outside diameter of said helical spring and a compressed length of said helical spring divided by an effective wire diameter of said helical spring, wherein said outside diameter of said helical spring said compressed length of said helical spring and said effective wire diameter of said helical spring are measured in inches;
a shade made of a flexible sheet material comprising a first end connected to said rotatable shell and a second end connected to a bottom rail;
a pair of side rails, each of said pair of side rails comprising a longitudinal engagement element comprising a first friction brake surface and a first fastener element for fastening said each of said pair of side rails to opposite sides of said window jamb;
said bottom rail comprising a brake assembly comprising a brake element having a second friction brake surface engageable to said first friction brake surface of said longitudinal engagement element of at least one of said each of said pair of side rails; and
a bias element disposed in said bottom rail operably engaged with said brake element whereby said bottom rail is positioned and maintained in a set position selectable from a first end portion to a second end portion of said each of said pair of side rails.

11. The window shade apparatus of claim 10 wherein said spring factor of said helical spring is greater than 350 inch.

12. The window shade apparatus of claim 10 wherein said spring factor of said helical spring is greater than 500 inch.

13. The window shade apparatus of claim 10 wherein said bottom rail comprises a means for attaching a weight.

14. The window shade apparatus of claim 10 wherein said longitudinal engagement element is a longitudinal slot in each of said pair of side rails, said bias element disposed in said bottom rail is a brake spring and said brake element is a brake shoe engageable in said longitudinal slot.

15. A window shade apparatus for latchless positioning, the shade installable in a window jamb and comprising:
a roller assembly comprising a rotatable shell supportable from said window jamb by a first roll support and a second roll support, said rotatable shell operably connected to said first roll support by a helical spring;
a shade made of a flexible sheet material comprising a first end connected to said rotatable shell and a second end connected to a bottom rail;
a pair of side rails, each of said pair of side rails comprising a longitudinal engagement slot having a first friction brake surface and a first fastener element for fastening said each of said pair of side rails to opposite sides of said window jamb;
said bottom rail comprising a grip portion facing an inward direction, a pair of brake assemblies, each of said pair of said brake assemblies engageable to said first friction brake surface of one of said pair of side rails, and a weight retaining portion for attaching a weight to said bottom rail;
said window shade apparatus comprising an application factor wherein a product of a compressed length of said helical spring, outer diameter of said helical spring, and a number of revolutions of said rotatable shell from a retracted position to two turns before a lockup condition of said roller assembly divided by a product of an effective wire diameter of said helical spring and a torque of said rotatable shell at said two turns before a lockup condition is at least 2000/pound, said compressed length of said helical spring, said outer diameter of said helical spring, and said effective wire diameter of said helical spring are measured in inches and said torque of said rotatable shell is measured in inch-pounds;
whereby said bottom rail is positioned and maintained in a set position selectable from an top end portion to a bottom end portion of said each of said pair of side rails.

16. The window shade apparatus of claim 15 wherein said application factor of said helical spring is greater than 3000/pound.

17. The window shade apparatus of claim 15 wherein said application factor of said helical spring is greater than 5000/pound.

18. The window shade apparatus of claim 15 wherein said first friction brake surface is a longitudinal ridge portion extending from a base portion of said longitudinal engagement slot.

19. The window shade apparatus of claim 15 wherein said first friction brake surface comprises a pair of longitudinal ridge portions extending from a base portion of said longitudinal engagement slot and said first fastener element is disposed between said pair of longitudinal ridge portions.

20. The window shade apparatus of claim 19 wherein each of said pair of brake assemblies comprises a brake shoe engageable with one of said pair of longitudinal ridge portions extending from a base portion of said longitudinal engagement slot.
